(19) United States
(12) Patent Application Publication
(10) Pub. No.: US 2015/0101696 A1
(43) Pub. Date: Apr. 16, 2015

(54) FUEL PIPE PROTECTIVE STRUCTURE

(71) Applicant: HONDA MOTOR CO., LTD., Tokyo (JP)

(72) Inventors: Kazuya ISHIKI, Wako (JP); Eiji NISHIJIMA, Wako (JP)

(73) Assignee: HONDA MOTOR CO., LTD., Tokyo (JP)

(21) Appl. No.: 14/505,498

(22) Filed: Oct. 3, 2014

(30) Foreign Application Priority Data
Oct. 15, 2013 (JP) 2013-214352

(51) Int. Cl. F02M 37/00

(52) U.S. Cl. CPC F02M 37/0017
USPC 138/103

(57) ABSTRACT

A fuel pipe protective structure includes a fuel pipe, a connecting member, and a protective member. The protective member is to protect a connection between the fuel pipe and the connecting member. The protective member includes a base and a cover. The base is to be connected to a vehicle body wall that defines an engine compartment. The cover is to be interposed between the connection and an internal combustion engine so as to cover the connection. The cover includes a guide. The guide is configured to cause the protective member to be plastically deformed in order to displace the connection in a receding direction in which the connection moves to avoid being caught by the internal combustion engine in a case where the internal combustion engine moves toward a vehicle interior upon collision of the vehicle.

### CROSS-REFERENCE TO RELATED APPLICATIONS

The present application claims priority under 35 U.S.C. §119 to Japanese Patent Application No. 2013-214352, filed Oct. 15, 2013, entitled “Fuel Pipe Protective Structure.” The contents of this application are incorporated herein by reference in their entirety.

### BACKGROUND

1. Field

The present disclosure relates to a fuel pipe protective structure.

2. Description of the Related Art

A fuel pipe is connected to an internal combustion engine mounted in an engine compartment. The fuel pipe disposed in the engine compartment is often disposed closer to a vehicle interior than the internal combustion engine so that the fuel pipe is less likely to be broken upon collision of a vehicle. Specifically, the fuel pipe is often disposed behind the internal combustion engine in a front-engine vehicle.

However, the internal combustion engine may move toward the vehicle interior within the engine compartment at the time of collision of the vehicle. If a fuel supply component, such as a control valve, connected to an upstream end of the fuel pipe is disposed closer to the vehicle interior than the internal combustion engine, the internal combustion engine would interfere with the fuel supply component. Unfortunately, the fuel supply component would be broken. Japanese Unexamined Patent Application Publication No. 2011-185228 discloses a structure for preventing a fuel supply component disposed near an internal combustion engine from being broken due to interference with the internal combustion engine. In this structure, a cover for the internal combustion engine has a sloping surface that slopes downward in a direction (hereinafter, referred to as “engine moving direction”) in which the internal combustion engine would move at the time of collision. The fuel supply component is positioned such that a lower surface of the fuel supply component is disposed at a higher level than an edge of the sloping surface of the cover in the engine moving direction. Consequently, if the internal combustion engine moves, the fuel supply component will slide on the sloping surface so as to move upward.

### SUMMARY

According to one aspect of the present invention, a fuel pipe protective structure includes a fuel pipe, a connecting member, and a protective member. The fuel pipe has a first end connected to an internal combustion engine mounted in an engine compartment of a vehicle and a second end disposed closer to a vehicle interior than the internal combustion engine. The connecting member is connected to the second end of the fuel pipe. The protective member protects a connection between the fuel pipe and the connecting member. The protective member includes a base fixed to a vehicle body wall that defines the engine compartment, and a cover interposed between the connection and the internal combustion engine so as to cover the connection. The cover includes a guide that causes the protective member to be plastically deformed in order to displace the connection in a receding direction in which the connection recedes to avoid being caught by the internal combustion engine when the internal combustion engine moves toward the vehicle interior upon collision of the vehicle.

According to another aspect of the present invention, a fuel pipe protective structure includes a fuel pipe, a connecting member, and a protective member. The fuel pipe has a first end to be connected to an internal combustion engine mounted in an engine compartment of a vehicle and a second end disposed closer to a vehicle interior than the internal combustion engine. The connecting member is connected to the second end of the fuel pipe. The protective member is to protect a connection between the fuel pipe and the connecting member. The protective member includes a base and a cover. The base is to be connected to a vehicle body wall that defines the engine compartment. The cover is to be interposed between the connection and the internal combustion engine so as to cover the connection. The cover includes a guide. The guide is configured to cause the protective member to be plastically deformed in order to displace the connection in a receding direction in which the connection moves to avoid being caught by the internal combustion engine in a case where the internal combustion engine moves toward the vehicle interior upon collision of the vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a plan view of an engine compartment in a first embodiment.

FIG. 2 is a side view illustrating a fuel pipe protective structure illustrated in FIG. 1.

FIG. 3 is a cross-sectional view of components taken along the line in FIG. 1.

FIG. 4 is a front view of a connection (or connection unit) illustrated in FIG. 3.

FIG. 5 is an exploded perspective view illustrating a protective member in FIG. 1.

FIG. 6 is a front view of the protective member in FIG. 1.

FIG. 7 is a right side view of the protective member in FIG. 1.

FIGS. 8A to 8D are diagrams explaining deformation of the protective member in FIG. 1 upon collision of a vehicle.

FIG. 9 is an exploded perspective view of a protective member according to a second embodiment.

FIG. 10 is a front view of the protective member of FIG. 9.

FIG. 11 is a left side view of the protective member of FIG.

FIGS. 12A to 12D are diagrams explaining deformation of the protective member of FIG. 9 upon collision of the vehicle.

### DESCRIPTION OF THE EMBODIMENTS

The embodiments will now be described with reference to the accompanying drawings, wherein like reference numerals designate corresponding or identical elements throughout the various drawings.

Embodiments will be described in detail with reference to the drawings. In the following description, it is assumed that a fuel pipe protective structure according to the present disclosure is applied to a front-engine vehicle in which an internal combustion engine 2 is mounted in an engine compartment 1 in front part of a vehicle. The terms “front” and “back” as used herein are intended to indicate directions with respect to the traveling direction of the vehicle. The terms “right” and “left” as used herein are intended to indicate directions with respect to the direction when viewed from the front of the vehicle.

### First Embodiment

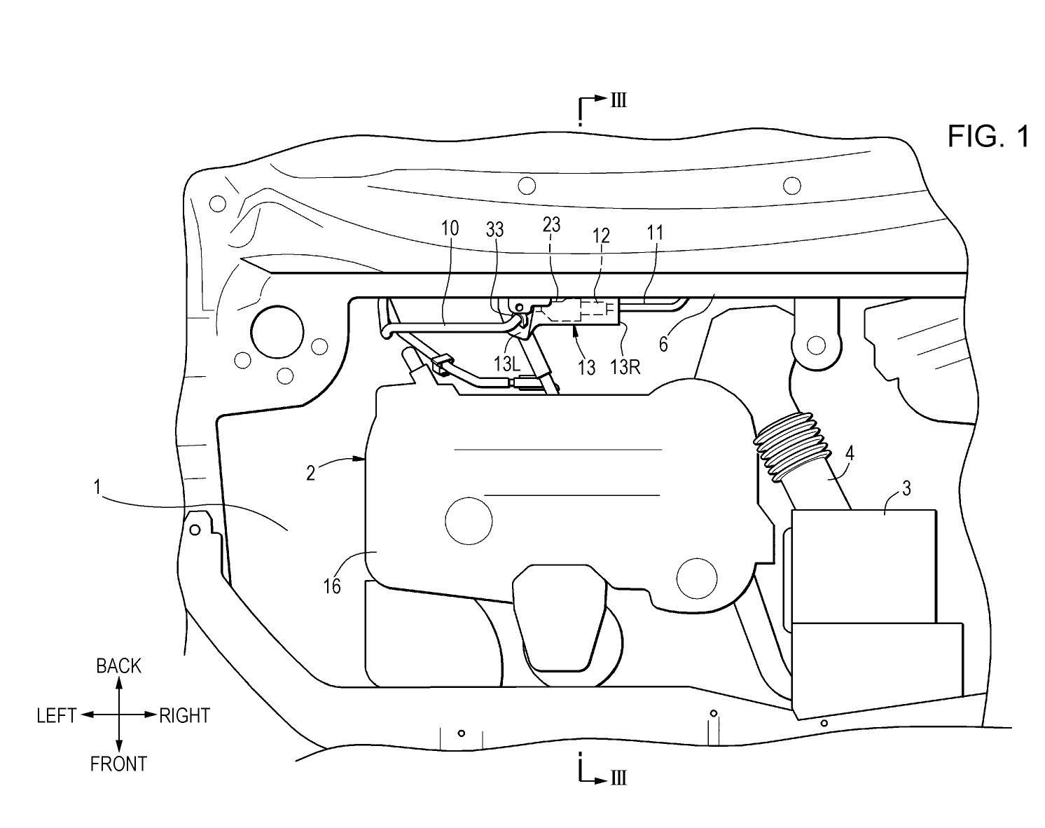

A protective structure for a fuel pipe 10 according to a first embodiment will now be described with reference to FIGS. 1 to 8D. Referring to FIG. 1, an in-line multicylinder internal combustion engine 2 is transversely mounted in substantially the middle of an engine compartment 1 in a direction (hereinafter, referred to as the “vehicle length direction”) along the length of a vehicle such that the internal combustion engine 2 is placed slightly to the right of the engine compartment 1. In the engine compartment 1, an air cleaner 3 is disposed on the right side of the internal combustion engine 2. An intake pipe 4 extending backward from the air cleaner 3 is connected to a rear surface of the internal combustion engine 2. A vehicle interior is located behind the engine compartment 1. A front bumper (not illustrated) is disposed in front of the engine compartment 1.

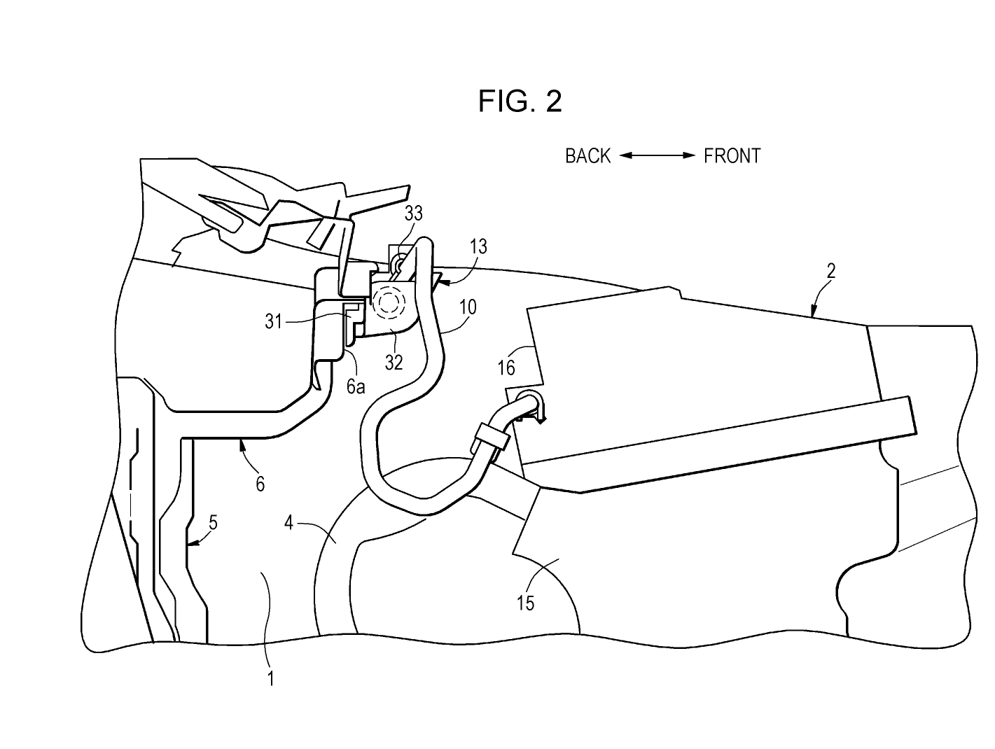

As illustrated in FIG. 2, the engine compartment 1 is separated from the vehicle interior by a dashboard lower member 5. An upper end of the dashboard lower member 5 is connected to a dashboard upper member 6 extending substantially in the vehicle length direction and a direction (hereinafter, referred to as the “vehicle width direction”) along the width of the vehicle. A hood (not illustrated) that defines an upper portion of the engine compartment 1 is disposed above the dashboard upper member 6. The rear surface of the internal combustion engine 2 is connected to a downstream portion of a fuel supply system for supplying fuel, compressed and delivered through a fuel pump (not illustrated), from a fuel tank (not illustrated), to the internal combustion engine 2.

The fuel supply system includes the fuel pipe 10, made of metal, having a downstream end connected to the internal combustion engine 2 and a resin feed hose 11 connected to an upstream end of the fuel pipe 10 with a connection unit 12. The connection unit 12 is disposed so as to extend in the vehicle width direction in front of the dashboard upper member 6. The connection unit 12 is housed in a protective member 13 for protecting the connection unit 12. The protective member 13 has a right opening 13R which faces rightward at a right end of the protective member 13 and a left opening 13L which faces leftward, upward, and forward at a left end thereof. The feed hose 11 extends substantially horizontally and rightward from the right opening 13R of the protective member 13. The fuel pipe 10 extends obliquely upward and obliquely forward from the left opening 13L of the protective member 13, curves and extends downward, curves and extends backward, curves so as to protrude backward and downward, extends obliquely forward and obliquely leftward, and connects to the internal combustion engine 2. As described above, the fuel pipe 10 is connected to the internal combustion engine 2 without passing through the shortest path. Consequently, if the connection unit 12 is displaced upon collision of the vehicle, the fuel pipe 10 would not be broken by tension as will be described later.

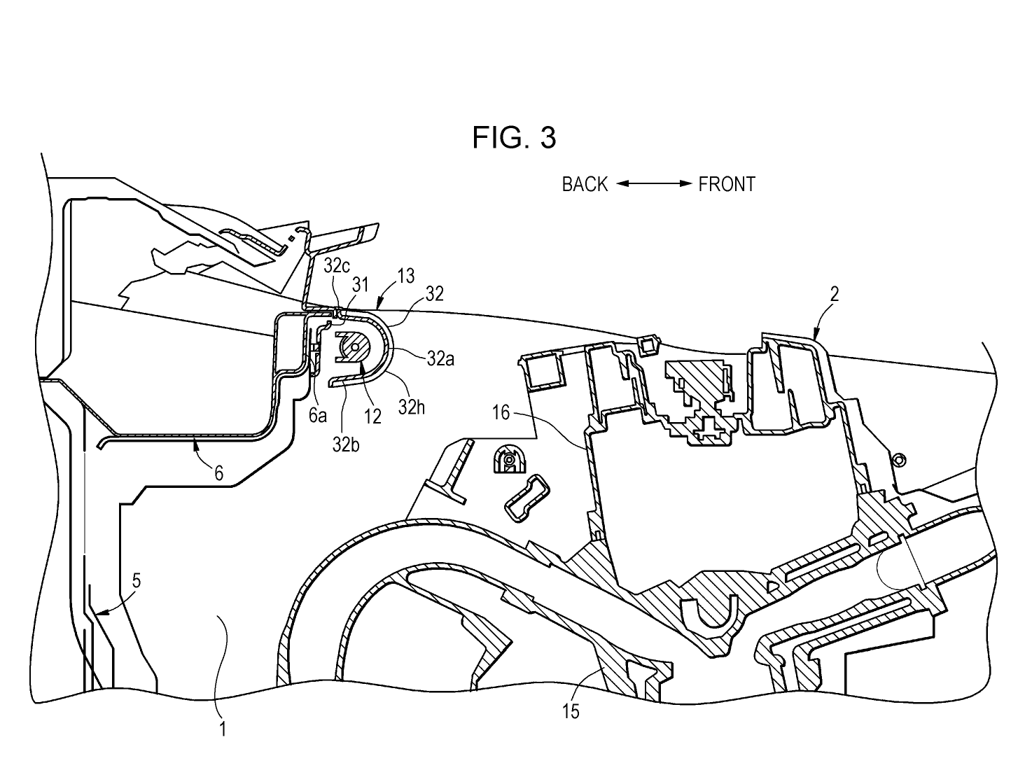

Referring to FIG. 3, the internal combustion engine 2 is disposed in a backward tilted state such that an upper portion is tilted backward. An upper surface of an engine body 15 including a cylinder block and a cylinder head is covered with a head cover 16. Upper part of the head cover 16 is disposed in front of the dashboard upper member 6 having a substantially rectangular box shape in cross section. The intake pipe 4 extending upward is located behind the engine body 15. Downstream part of the intake pipe 4 curves forward and connects to a rear surface of the engine body 15 (cylinder head). The protective member 13, which houses the connection unit 12, is positioned at substantially the same level as that of an upper end of a rear surface of the head cover 16. The protective member 13 is fixed to a front wall 6a of the dashboard upper member 6. The front wall 6a extends substantially vertically.

The connection unit 12 may have a well-known structure for connecting the fuel pipe 10 and the feed hose 11. The structure of the connection unit 12 and a procedure of connecting the fuel pipe 10 and the feed hose 11 with the connection unit 12 will now be described roughly.

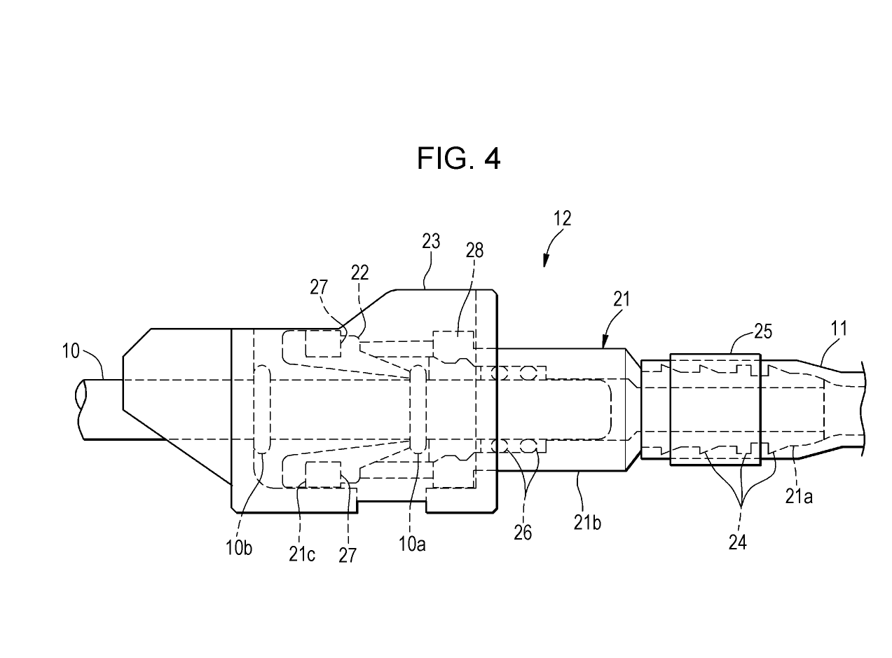

As illustrated in FIG. 4, the connection unit 12 includes a resin connector 21 secured to the end of the fuel pipe 10 and a locking member 22. The connector 21 is substantially cylindrical. The connector 21 has a first end portion through which the downstream end of the fuel pipe 10 extends and a second end portion over which an upstream end of the feed hose 11 is fitted. The fuel pipe 10 and the connector 21 are secured relative to each other by the locking member 22. To prevent the connector 21 from being separated from the fuel pipe 10, a resin anti-separation holder 23 is attached to the fuel pipe 10 and the connector 21 so as to extend over both of them.

Specifically, the fuel pipe 10 and the feed hose 11 are connected by the connection unit 12 as follows. The fuel pipe 10 includes a first flange 10a and a second flange 10b arranged in that order from the end (downstream end) of the pipe and spaced apart from each other at a predetermined distance. Each of the first flange 10a and the second flange 10b annularly protrudes radially outward from the fuel pipe 10. The connector 21 includes a small diameter portion 21a, an intermediate diameter portion 21b, and a large diameter portion 21c arranged in that order from the end thereof adjacent to the feed hose 11. The small diameter portion 21a has annular ribs 24 on an outer circumferential surface thereof so that the feed hose 11 fitted over the small diameter portion 21a is not prone to separate therefrom. A band 25 is attached to an outer circumferential surface of the feed hose 11 fitted over the small diameter portion 21a. The feed hose 11 is prevented from being separated from the small diameter portion 21a by tightening the band 25. The intermediate diameter portion 21b is used for connection with the fuel pipe 10. The fuel pipe 10 is fitted directly in the intermediate diameter portion 21b or indirectly fitted within the intermediate diameter portion 21b with a pair of O-rings arranged between the fuel pipe 10 and the intermediate diameter portion 21b. The large diameter portion 21c has a pair of openings 27 arranged vertically in FIG. 4. The large diameter portion 21c functions as an engagement unit to allow the locking member 22 to engage with the openings 27 so as to define a relative position of the locking member 22. A seal 28 is disposed within the large diameter portion 21c such that the seal 28 is interposed between the fuel pipe 10 and the large diameter portion 21c adjacent to the intermediate diameter portion 21b. The first flange 10a of the fuel pipe 10 is located next to the seal 28. A distal end of the locking member 22 engages with the first flange 10a, thus positioning the fuel pipe 10 relative to the locking member 22, or the connector 21.

The locking member 22 is elastically deformable. Specifically, the distal end of the locking member 22 to engage with the first flange 10a is deformable radially outward so that the fuel pipe 10 can be inserted to a predetermined position while the locking member 22 is attached to the connector 21. Furthermore, a proximal portion of the locking member 22 to engage with the openings 27 of the connector 21 is deformable radially inward so that the locking member 22 can be easily disengaged from the openings 27 by grasping a proximal end of the locking member 22 projecting from the connector 21.

The second flange 10b of the fuel pipe 10 is located closer to a proximal end of the fuel pipe 10 than the locking member 22 so that the second flange 10b does not interfere with the locking member 22 when the locking member 22 is disengaged from the connector 21. The anti-separation holder 23 is attached to the fuel pipe 10 and the connector 21 such that the holder 23 engages with a face of the second flange 10b of the fuel pipe 10 adjacent to the proximal end of the fuel pipe 10 and also partly engages with a shoulder provided between the large diameter portion 21c and the intermediate diameter portion 21b of the connector 21. Consequently, the connector 21 is prevented from being separated from the fuel pipe 10. The detailed structure of the connector 21 and a procedure of detaching the connector 21 are described in Japanese Unexamined Patent Application Publication No. 2008-309187, the entire contents of which are incorporated herein by reference.

As described above, the fuel pipe 10 and the connector 21 are doubly connected by the locking member 22 and the anti-separation holder 23, and the connector 21 and the feed hose 11 are doubly connected by the annular ribs 24 of the small diameter portion 21a and the band 25. If front part of a vehicle body is crashed due to a vehicle collision and the internal combustion engine 2 moves backward, or toward the vehicle interior within the engine compartment 1, the connection unit 12 may be caught between the dashboard upper member 6 and the internal combustion engine 2 and accordingly be broken. Unfortunately, fuel may leak from a broken part. According to the first embodiment, therefore, the protective member 13 for protecting the connection unit 12 is disposed.

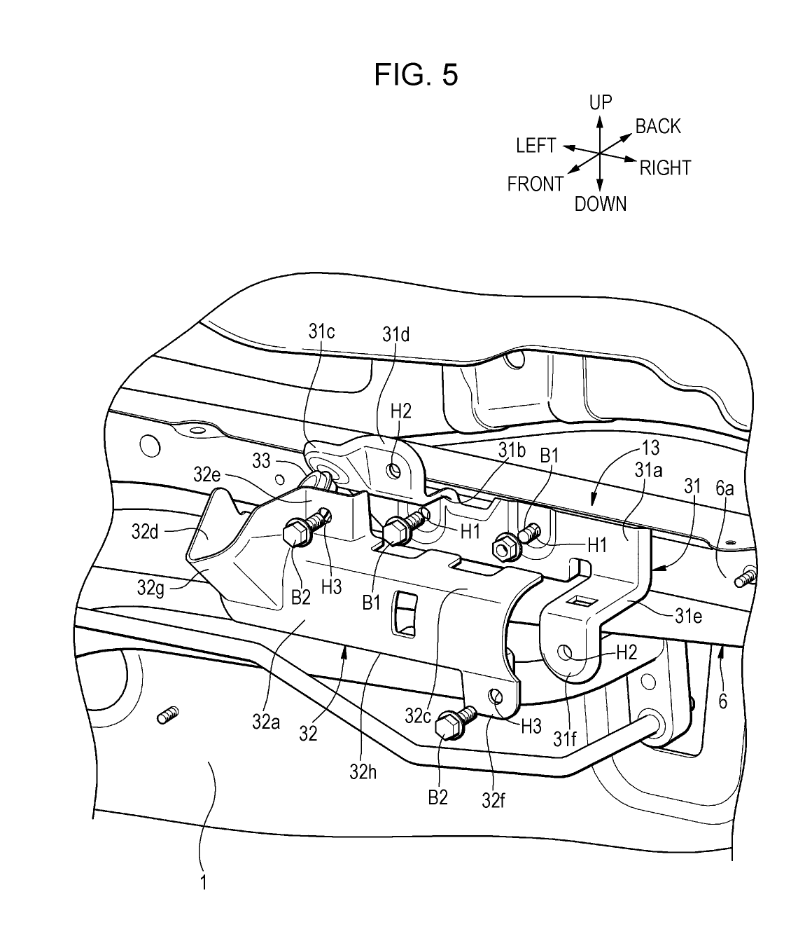

As illustrated in FIG. 5, the protective member 13, which is included in the protective structure for the fuel pipe 10 according to the first embodiment, includes a steel base 31 fastened to the front wall 6a of the dashboard upper member 6 (refer to FIG. 3) by two bolts B1 and a steel cover 32 fastened to the base 31 by two bolts B2 to define a space for receiving the connection unit 12 between the base 31 and the cover 32. After the cover 32 is fixed to the base 31, the cover 32 covers the connection unit 12 from the front (such that the cover 32 is interposed between the connection unit 12 and the internal combustion engine 2), as illustrated in FIG. 3.

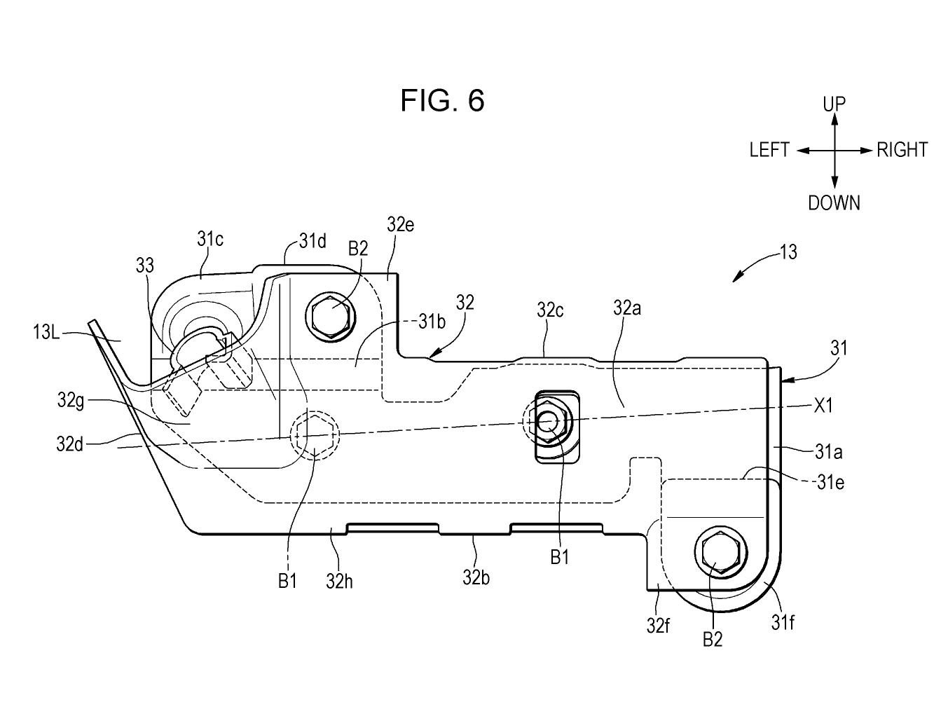

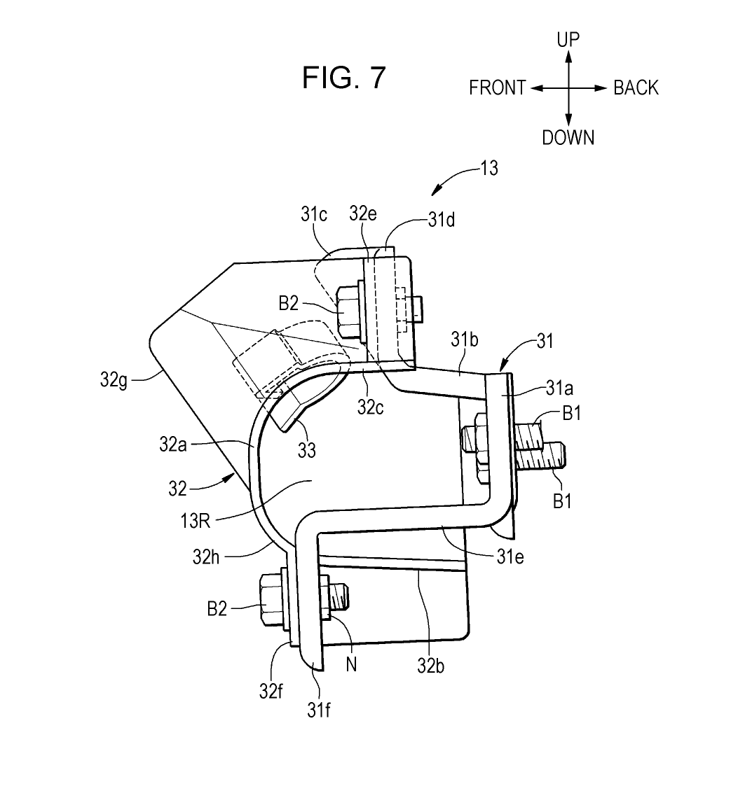

As illustrated in FIGS. 5 to 7, the base 31 includes a base portion 31a, an upper projecting portion 31b, a sloping portion 31c, an upward extending portion 31d, a lower projecting portion 31e, and a downward extending portion 31f. In the base 31 fixed to the dashboard upper member 6, the base portion 31a extends substantially vertically in the vehicle width direction. The upper projecting portion 31b extends forward from left part of an upper edge of the base portion 31a. The sloping portion 31c extends forward and upward from left part of a front edge of the upper projecting portion 31b. The upward extending portion 31d extends upward from right part of the front edge of the upper projecting portion 31b and connects to the sloping portion 31c. The lower projecting portion 31e extends forward from right end part of a lower edge of the base portion 31a. The downward extending portion 31f extends downward from a front edge of the lower projecting portion 31e. The base portion 31a has two bolt through-holes H1 arranged in substantially the middle of the base portion 31a in a direction along the height of the vehicle such that the bolt through-holes H1 are spaced apart from each other in the vehicle width direction. The base 31 is fastened to the dashboard upper member 6 by the two bolts B1 extending through the respective bolt through-holes H1. The sloping portion 31c has a rectangular hole (see FIG. 5) to which a C-shaped clip (see FIGS. 6 and 7) for holding the fuel pipe 10 is attached such that the clip faces obliquely downward. Specifically, the sloping portion 31c serves as a support that supports the fuel pipe 10. The sloping portion 31c is located above a section (where the bolts B1 and the two bolt through-holes H1 through which the bolts B1 extend are arranged) of the base 31 fixed to the dashboard upper member 6. The upward extending portion 31d and the downward extending portion 31f each have a bolt through-hole H2. A nut N (see FIG. 7) used to fix the cover 32 is secured to a rear surface of each of the upward extending portion 31d and the downward extending portion 31f by welding.

The cover 32 includes a front wall 32a, a lower wall 32b, an upper wall 32c, a left wall 32d, an upward extending wall 32e, and a downward extending wall 32f. The cover 32 protrudes forward and has an opened rear surface. In other words, the cover 32 has a laterally-facing U-shaped cross section (refer to FIG. 3). The upper wall 32c has a cutout, serving as the left opening 13L, in left end part thereof. In this part where the left opening 13L is provided, as illustrated in FIG. 5, the front wall 32a forwardly projects so as to be gradually away from the dashboard upper member 6 in an upward direction to increase an internal space of the protective member 13, thus defining a sloping wall 32g. The upward extending wall 32e is located to the right of the left opening 13L so as to face the upward extending portion 31d of the base 31. As illustrated in FIG. 3, the upper wall 32c is smoothly connected to the front wall 32a with no bends, except for the above-described part where the left opening 13L is disposed. The downward extending wall 32f extends from right end part of a lower edge of the front wall 32a. The front wall 32a is smoothly connected to the lower wall 32b across the entire length thereof in the vehicle width direction with no bends, except for the part from which the downward extending wall 32f extends. In other words, the front wall 32a is connected to the lower wall 32b by curved part 32h. An end of the curved part 32h connected to the front wall 32a is inclined relative to a vertical direction so as to extend obliquely forward. The cover 32 is shaped such that the sloping wall 32g is smoothly connected to the curved part 32h in side view (FIG. 7), more specifically, a lower end of the sloping wall 32g is connected to an upper end of the curved part 32h. The lower end of the sloping wall 32g may be connected to the curved part 32h at a lower level, where the curved part 32h is more steeply inclined, than the upper end of the curved part 32h (which is inclined so as to extend forward and upward and is connected to the front wall 32a).

Referring to FIGS. 5 and 6, each of the upward extending wall 32e and the downward extending wall 32f of the cover 32 has a bolt through-hole H3. The cover 32 is fastened to the base 31 by the two bolts B2 extending through the respective bolt through-holes H3. The left bolt through-holes H2 and H3 and the left bolt B2 are arranged at a higher level than the two bolts B1 to fasten the base 31 to the dashboard upper member 6. The lower bolt through-holes H2 and H3 and the lower bolt B2 are arranged at a lower level than the two bolts B1 to fasten the base 31 to the dashboard upper member 6. The cover 32 is secured to the base 31 such that the upward extending wall 32e and the downward extending wall 32f are in contact with the base 31.

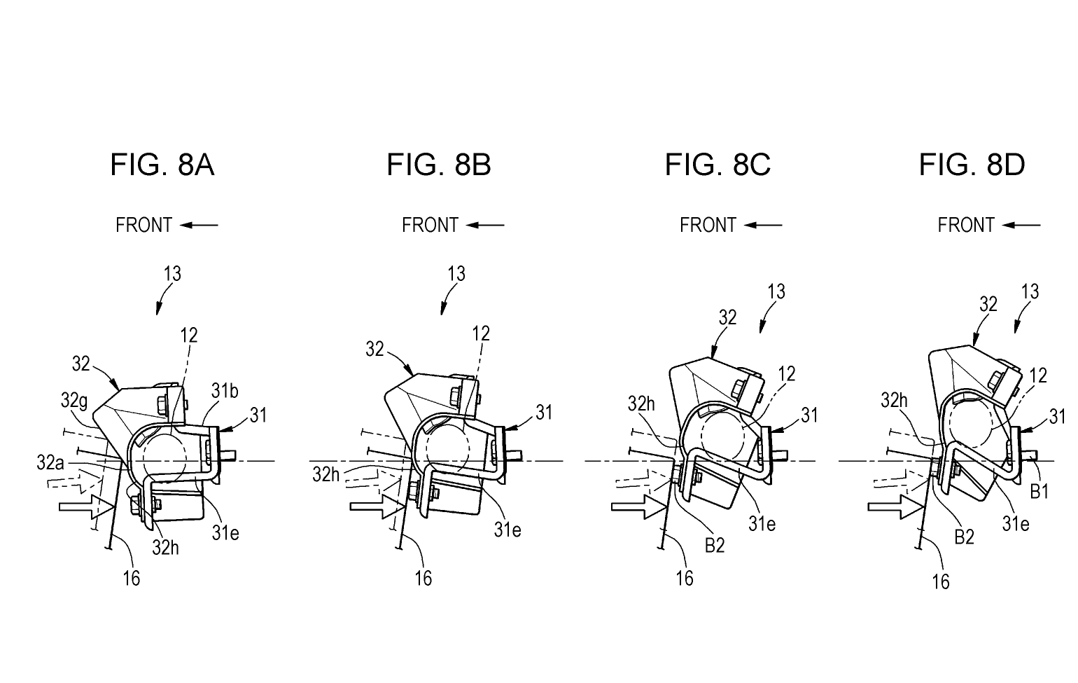

How the above-described protective structure for the fuel pipe 10 behaves at the time of collision of the vehicle will now be described with reference to FIGS. 8A to 8D.

Referring to FIG. 8A, when the internal combustion engine 2 moves backward upon front collision of the vehicle, the head cover 16 comes into contact with the front wall 32a of the cover 32 of the protective member 13. In FIGS. 8A to 8D, a solid line indicates the internal combustion engine 2 moved horizontally backward. The upper end of the rear surface of the head cover 16 is in contact with lower part of the sloping wall 32g. Upward force accordingly acts on the cover 32. Consequently, the protective member 13 starts to be plastically deformed so as to shift upward as illustrated in FIG. 8B. Specifically, the sloping wall 32g functions as a guide to displace the connection unit 12 upward (in a receding direction in which the connection unit 12 recedes to avoid being caught by the internal combustion engine 2). Plastic deformation of the protective member 13 to upwardly displace the connection unit 12 is achieved mainly by upwardly turning the upper projecting portion 31b and the lower projecting portion 31e of the base 31.

When the internal combustion engine 2 moves upward, the upper end of the rear surface of the head cover 16 comes into contact with upper part of the sloping wall 32g as indicated by a phantom line. Upward force acts on the cover 32 in a manner similar to the above case. If the internal combustion engine 2 moves further upward and the upper end of the rear surface of the head cover 16 comes into contact with the protective member 13 at a level higher than an upper end of the sloping wall 32g, no force to cause upward deformation of the protective member 13 would be produced. It is therefore preferred that the protective member 13 be disposed at a level as high as possible.

When the protective member 13 shifts upward as illustrated in FIG. 8B, the upper end of the rear surface of the head cover 16 comes into contact with the curved part 32h, so that the curved part 32h applies upward force to the cover 32. In other words, the curved part 32h also functions as a guide to upwardly displace the connection unit 12.

When the internal combustion engine 2 moves further backward from a position illustrated in FIG. 8B, the protective member 13 is gradually deformed plastically as illustrated in FIGS. 8C and 8D, thus further upwardly displacing the connection unit 12. Referring to FIGS. 8C and 8D, the rear surface of the head cover 16 is in contact with the lower bolt B2 to fasten the cover 32 to the base 31, thus upwardly turning the lower projecting portion 31e of the base 31. At this time, the lower projecting portion 31e of the base 31 upwardly displaces the connection unit 12 and the curved part 32h serves as a movement margin for plastic deformation.

In the above-described plastic deformation of the protective member 13, since the two bolts B1 to fasten the base 31 to the dashboard upper member 6 are arranged substantially horizontally as illustrated in FIG. 6, the base portion 31a of the base 31 tends to turn in a direction in which the cover 32 is upwardly displaced. In addition, since the lower bolt B2 of the two bolts B2 to fasten the cover 32 to the base 31 is disposed at a lower level than a line X1 extending through the two bolts B1, the cover 32 is deformed so as to upwardly turn about the lower bolt B2 such that lower part of the cover 32 does not turn outward and upward during plastic deformation of the cover 32. This facilitates upward displacement of the connection unit 12 without the connection unit 12 being exposed.

Furthermore, since the sloping portion 31c of the base 31 supporting the fuel pipe 10 is disposed at a higher level than the two bolts B1 to fix the base 31 to the dashboard upper member 6, the fuel pipe 10 is less likely to be broken by tension when displaced.

### Second Embodiment

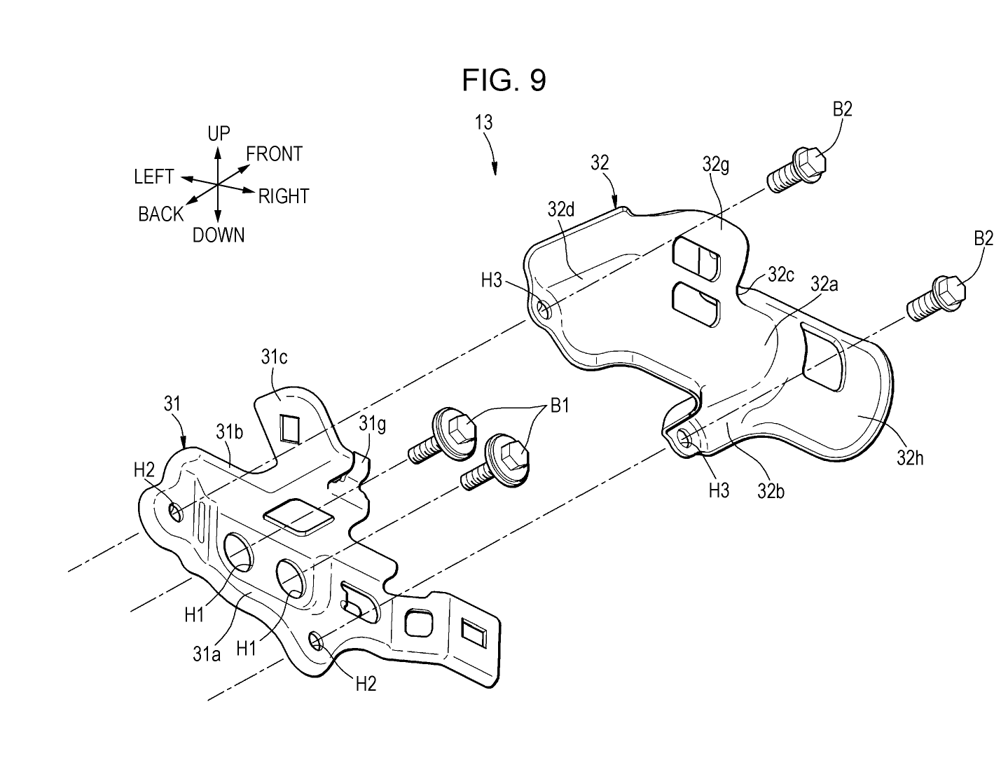

A protective structure for a fuel pipe 10 according to a second embodiment will now be described with reference to FIGS. 9 to 12D. The second embodiment differs from the first embodiment in the connection structures of the portions and parts of the base 31 and the cover 32 of the protective member 13. The same or similar components as those in the first embodiment are designated by the same reference numerals and the description thereof is omitted as much as possible.

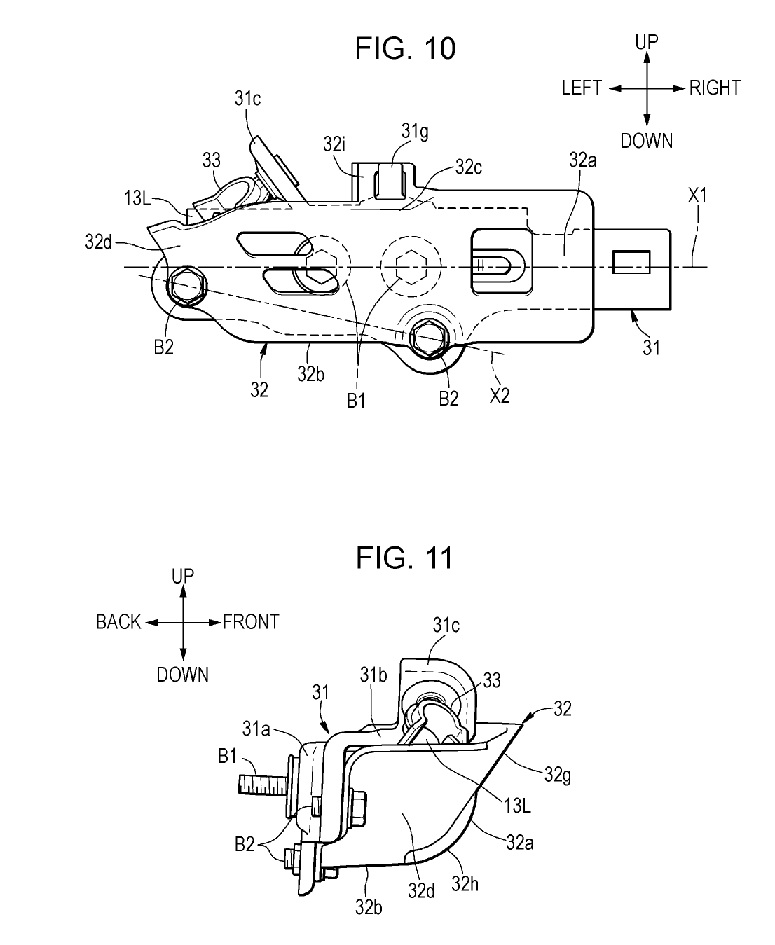

As illustrated in FIGS. 9 to 11, a base 31 includes a base portion 31a, an upper projecting portion 31b, a sloping portion 31c, and an engagement lug 31g. In the base 31 fixed to a dashboard upper member 6, the base portion 31a extends substantially vertically in the vehicle width direction. The upper projecting portion 31b projects forward from middle part in the vehicle width direction of an upper edge of the base portion 31a. The sloping portion 31c extends leftward and upward from a left edge of the upper projecting portion 31b. The engagement lug 31g extends upward from a front edge of the upper projecting portion 31b in middle part in the vehicle width direction of the base 31. The sloping portion 31c has a rectangular hole (see FIG. 9) to which a C-shaped clip 33 (see FIGS. 10 and 11) for holding the fuel pipe 10 is attached such that the C-shaped clip 33 faces leftward and downward. In other words, the sloping portion 31c serves as a support that supports the fuel pipe 10. The sloping portion 31c is disposed at a higher level than a section (where two bolt through-holes H1 are arranged) of the base 31 fixed to the dashboard upper member 6. The engagement lug 31g engages with a cover 32 to secure upper part of the cover 32 so that the cover 32 is prevented from moving in all directions except in the upward direction.

The cover 32 includes a front wall 32a, a lower wall 32b, an upper wall 32c, and a left wall 32d. The cover 32 protrudes forward and has an opened rear surface. In other words, the cover 32 has a laterally-facing U-shaped cross section (refer to FIG. 3). The upper wall 32c has a cutout, serving as a left opening 13L, in left end part thereof. In this part where the left opening 13L is provided, as illustrated in FIG. 11, the front wall 32a forwardly projects so as to be gradually away from the dashboard upper member 6 in the upward direction to increase an internal space of a protective member 13, thus defining a sloping wall 32g. As illustrated in FIG. 3, the upper wall 32c is smoothly connected to the front wall 32a with no bends, except for the above-described part where the left opening 13L is disposed. Additionally, the front wall 32a is smoothly connected to the lower wall 32b across the entire length thereof in the vehicle width direction with no bends. In other words, the front wall 32a is connected to the lower wall 32b by curved part 32h. The cover 32 is fixed to the dashboard upper member 6 such that the lower wall 32b and the upper wall 32c slightly slope upward gradually in a forward direction.

As illustrated in FIGS. 9 and 10, the cover 32 has two bolt through-holes H3 arranged in left and lower ends of the cover 32. The cover 32 is fastened to the base 31 by two bolts B2 extending through the respective bolt through-holes H3. The bolt through-hole H3 and the bolt B2 in the left end of the cover 32 are arranged at a slightly lower level than two bolts B1 to fasten the base 31 to the dashboard upper member 6. The bolt through-hole H3 and the bolt B2 in the lower end of the cover 32 are arranged at a level lower than the two bolts B1 to fasten the base 31 to the dashboard upper member 6 and are located toward the right of the right bolt B1. The cover 32 further includes an engagement tab 32i in substantially middle part thereof in the vehicle width direction. The engagement tab 32i extends upward from a rear end of the upper wall 32c and has a rectangular hole. The engagement lug 31g of the base 31 is inserted into the rectangular hole of the cover 32 in a tilted state such that the engagement lug 31g engages with the engagement tab 32i, the cover 32 is pivoted about the engagement tab 32i such that lower part of the cover 32 moves to the base 31 (backward), and the cover 32 is fastened to the base 31 by the two bolts B2.

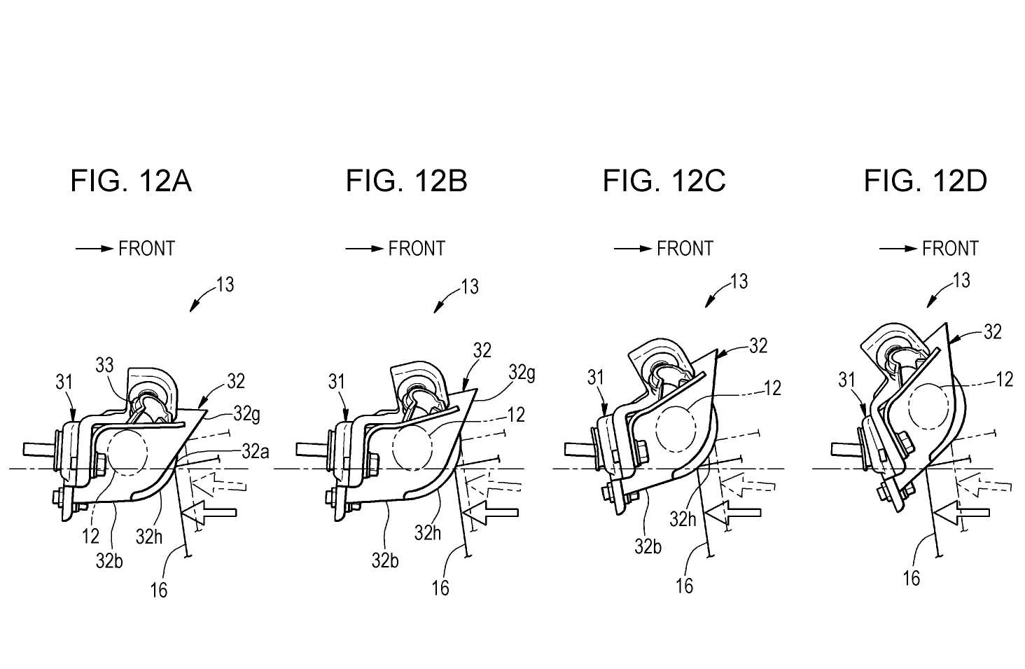

How the above-described protective structure for the fuel pipe 10 behaves at the time of collision of the vehicle will now be described with reference to FIGS. 12A to 12D.

Referring to FIG. 12A, when an internal combustion engine 2 moves backward upon front collision of the vehicle, a head cover 16 comes into contact with the front wall 32a of the cover 32 of a protective member 13. In FIGS. 12A to 12D, a solid line indicates the internal combustion engine 2 moved horizontally backward. An upper end of a rear surface of the head cover 16 is in contact with upper part of the curved part 32h. Since the lower wall 32b and the upper wall 32c of the cover 32 slope upward and forward, upward force accordingly acts on the cover 32. Consequently, the protective member 13 starts to be plastically deformed so as to shift upward as illustrated in FIG. 12B. Specifically, the curved part 32h functions as a guide to displace a connection unit 12 upward (in the receding direction in which the connection unit 12 recedes to avoid being caught by the internal combustion engine 2).

When the internal combustion engine 2 moves upward, the upper end of the rear surface of the head cover 16 comes into contact with the sloping wall 32g as indicated by a phantom line. Upward force acts on the cover 32 in a manner similar to the above case. When the protective member 13 shifts upward as illustrated in FIG. 12B, the upper end of the rear surface of the head cover 16 is in contact with the curved part 32h, so that the curved part 32h applies upward force to the cover 32. In other words, the sloping wall 32g and the curved part 32h function as a guide to upwardly displace the connection unit 12.

If the internal combustion engine 2 moves further upward and the upper end of the rear surface of the head cover 16 comes into contact with the protective member 13 at a level higher than an upper end of the sloping wall 32g, no force to cause upward deformation would be produced. It is therefore preferred that the protective member 13 be disposed at a level as high as possible.

When the internal combustion engine 2 moves further backward from a position illustrated in FIG. 12B, the protective member 13 is gradually deformed plastically as illustrated in FIGS. 12C and 12D, thus further upwardly displacing the connection unit 12. Referring to FIGS. 12C and 12D, the upper end of the rear surface of the head cover 16 comes into contact with lower part of the curved part 32h and then comes into contact with the lower wall 32b. The curved part 32h smoothly connected to the lower wall 32b displaces the connection unit 12 smoothly upward and also serves as a movement margin for plastic deformation.

In the above-described plastic deformation of the protective member 13, since the two bolts B1 to fasten the base 31 to the dashboard upper member 6 are arranged substantially horizontally as illustrated in FIG. 10, the base portion 31a of the base 31 tends to turn in a direction in which the cover 32 is upwardly displaced. In addition, since the two bolts B2 to fasten the cover 32 to the base 31 are arranged at a lower level than a line X1 extending through the two bolts B1, the cover 32 is deformed so as to upwardly turn about a line X2 extending through the two bolts B2 such that lower part of the cover 32 does not turn outward and upward during plastic deformation of the cover 32. This facilitates upward displacement of the connection unit 12 without the connection unit 12 being exposed.

Furthermore, since the sloping portion 31c of the base 31 supporting the fuel pipe 10 is disposed at a higher level than the two bolts B1 to fix the base 31 to the dashboard upper member 6, the fuel pipe 10 is less likely to be broken by tension when displaced.

The above-described embodiments are for illustrative purposes only, and should not be construed as limiting. Alterations, modifications, and variations may be effected to the particular embodiments by those skilled in the art without departing from the scope of the present disclosure. For example, although the feed hose 11 is connected to the upstream end of the fuel pipe 10 by the connection unit 12 in the above-described embodiments, a connection is not limited to the connection unit 12. The connection may be any connection between fuel supply components, such as a connection between the fuel pipe 10 and a flow control valve. Although the embodiments have been described with respect to the case where the present disclosure is applied to a front-engine vehicle, the present disclosure can be applied to a rear-engine vehicle in which the internal combustion engine 2 is mounted in rear part of a vehicle body. In this case, the fuel pipe 10 is disposed in front of the internal combustion engine 2. Although the embodiments have been described with respect to the case where the protective member 13 is configured to upwardly displace the connection unit 12 upon collision of the vehicle, the receding direction in which the connection unit 12 is displaced is not limited to the upward direction. The connection unit 12 may be displaced downward, leftward, or rightward. As regards materials for the base 31 and the cover 32, the base 31 may be made of a material having stiffness higher than that of a material for the cover 32. Although the embodiments have been described with respect to the case where the internal combustion engine 2 directly collide with the protective member 13 upon collision of the vehicle, the internal combustion engine 2 may indirectly collide with the protective member 13. An auxiliary device of the internal combustion engine 2 or a component moved in response to movement of the internal combustion engine 2 may collide with the protective member 13. In addition, a specific structure of each component or part, arrangement of the components and parts, the number of components or parts, and angles of the components and parts may be changed as appropriate without departing from the scope of the present disclosure. Furthermore, all of the components of the protective structure for the fuel pipe 10 described in the embodiments are not absolutely needed. The components thereof may be selected as appropriate.

According to an aspect of the present application, a fuel pipe protective structure includes a fuel pipe (10) having a first end connected to an internal combustion engine (2) mounted in an engine compartment (1) of a vehicle and a second end disposed closer to a vehicle interior than the internal combustion engine (2), a connecting member (feed hose 11) connected to the second end of the fuel pipe (10), and a protective member (13) that protects a connection (connection unit 12) between the fuel pipe (10) and the connecting member (11). The protective member (13) includes a base (31) fixed to a vehicle body wall (dashboard upper member 6) that defines the engine compartment (1) and a cover (32) interposed between the connection (12) and the internal combustion engine (2) so as to cover the connection. The cover (32) includes a guide (32g, 32h) that causes the protective member to be plastically deformed in order to displace the connection (12) in a receding direction (upward direction) in which the connection recedes to avoid being caught by the internal combustion engine (2) when the internal combustion engine (2) moves toward the vehicle interior upon collision of the vehicle.

In this structure, if the connection between the fuel pipe and the connecting member has low strength, the connection can be protected by the cover at the time of collision of the vehicle, thus preventing breakage of the connection and leakage of fuel from the connection. In addition, since the guide of the cover displaces the connection in the receding direction, the position of the connection is free from restriction, thus providing high flexibility of layout.

In this aspect, the guide may include a sloping wall (32g) that is at least part of the cover (32) extending outwardly so as to be gradually away from the vehicle body wall (6) in the receding direction (upward direction), and curved part (32h) formed by curving part of the cover (32) facing in a direction (downward direction) opposite to the receding direction (upward direction).

In this structure, the sloping wall functions as a guiding member and ensures the displacement of the connection. Additionally, the curved part can smoothly displace the connection upon collision of the vehicle and provide a movement margin for plastic deformation.

In this aspect, the cover (32) may be secured to the base (31) by a plurality of fasteners (B2, H3) and at least one of the fasteners (B2, H3) is disposed on an opposite side (lower side) of a section (B1, H1) of the base (31) fixed to the vehicle body wall (6) from part of the base (31) extending in the receding direction (upward direction).

In this structure, the cover can be prevented from turning outward and upward. Additionally, the cover can be plastically deformed so as to turn about the fastener disposed on the opposite side of the section of the base fixed to the vehicle body wall from the part of the base extending in the receding direction. Thus, the connection can be more smoothly displaced in the receding direction.

In this aspect, the base (31) may include a support (sloping portion 31c) that supports the fuel pipe (10). The support (31c) may be disposed adjacent to the part of the base (31) extending in the receding direction (upward direction) relative to the section (B1, H1) of the base (31) fixed to the vehicle body wall (6).

In this structure, the fuel pipe can be prevented from being broken by tension when displaced.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel pipe protective structure comprising:
a fuel pipe having a first end connected to an internal combustion engine mounted in an engine compartment of a vehicle and a second end disposed closer to a vehicle interior than the internal combustion engine;
a connecting member connected to the second end of the fuel pipe; and
a protective member that protects a connection between the fuel pipe and the connecting member,
the protective member including
a base fixed to a vehicle body wall that defines the engine compartment, and
a cover interposed between the connection and the internal combustion engine so as to cover the connection,
the cover including
a guide that causes the protective member to be plastically deformed in order to displace the connection in a receding direction in which the connection recedes to avoid being caught by the internal combustion engine when the internal combustion engine moves toward the vehicle interior upon collision of the vehicle.

2. The protective structure according to claim 1, wherein the guide includes
a sloping wall that is at least part of the cover extending outwardly so as to be gradually away from the vehicle body wall in the receding direction, and
curved part formed by curving part of the cover facing in a direction opposite to the receding direction.

3. The fuel pipe protective structure according to claim 1, wherein the cover is secured to the base by a plurality of fasteners and at least one of the fasteners is disposed on an opposite side of a section of the base fixed to the vehicle body wall from part of the base extending in the receding direction.

4. The fuel pipe protective structure according to claim 3, wherein the base includes a support that supports the fuel pipe and the support is disposed adjacent to the part of the base extending in the receding direction relative to the section of the base fixed to the vehicle body wall.

5. A fuel pipe protective structure comprising:
a fuel pipe having a first end to be connected to an internal combustion engine mounted in an engine compartment of a vehicle and a second end disposed closer to a vehicle interior than the internal combustion engine;
a connecting member connected to the second end of the fuel pipe; and
a protective member to protect a connection between the fuel pipe and the connecting member, the protective member comprising:
a base to be connected to a vehicle body wall that defines the engine compartment; and
a cover to be interposed between the connection and the internal combustion engine so as to cover the connection, the cover comprising:
a guide configured to cause the protective member to be plastically deformed in order to displace the connection in a receding direction in which the connection moves to avoid being caught by the internal combustion engine in a case where the internal combustion engine moves toward the vehicle interior upon collision of the vehicle.

6. The protective structure according to claim 5, wherein the guide includes
a sloping wall comprising at least part of the cover extending outwardly so as to be gradually away from the vehicle body wall in the receding direction, and
curved part provided by curving part of the cover facing in a direction opposite to the receding direction.

7. The fuel pipe protective structure according to claim 5, wherein the cover is secured to the base by a plurality of fasteners and at least one of the plurality of fasteners is disposed on an opposite side of a section of the base connected to the vehicle body wall from part of the base extending in the receding direction.

8. The fuel pipe protective structure according to claim 7, wherein the base includes a support that supports the fuel pipe and the support is disposed adjacent to the part of the base extending in the receding direction relative to the section of the base connected to the vehicle body wall.

9. The fuel pipe protective structure according to claim 5, wherein the base is connected to the vehicle body wall by a first fastener, and the cover is connected to the base by second and third fasteners, and
wherein the second fastener is provided at a higher level than the first fastener in a vertical direction, and the third fastener is provided at a lower level than the first fastener in the vertical direction.
